(19) United States
(12) Patent Application Publication
(10) Pub. No.: US 2021/0241509 A1
(43) Pub. Date: Aug. 5, 2021

(54) METHOD AND APPARATUS FOR IMAGE PROCESSING, DEVICE FOR IMAGE PROCESSING, AND STORAGE MEDIUM

(71) Applicant: Beijing SenseTime Technology Development Co., Ltd., Beijing (CN)

(72) Inventors: Tong LI, Beijing (CN); Weiliang ZHANG, Beijing (CN); Wentao LIU, Beijing (CN); Chen QIAN, Beijing (CN)

(21) Appl. No.: 17/234,957

(22) Filed: Apr. 20, 2021

Related U.S. Application Data
(63) Continuation of application No. PCT/CN2020/093447, filed on May 29, 2020.

(30) Foreign Application Priority Data
Nov. 29, 2019 (CN) 201911205289.X

(51) Int. Cl. G06T 11/60; G06T 7/00; G06K 9/00; G06K 9/46

(52) U.S. Cl. CPC G06T 11/60; G06T 7/97; G06T 2207/30196; G06K 9/4671; G06T 2207/20221; G06K 9/00362

(57) ABSTRACT

Disclosed are a method and apparatus for image processing, a device for image processing, and a storage medium. The method for image processing includes: acquiring a first replacement image of a target part at a first posture; determining a posture parameter of the target part at a second posture in a first image; transforming the first replacement image into a second replacement image corresponding to the second posture according to the posture parameter; and fusing the second replacement image to the target part in the first image to obtain a second image.

### CROSS-REFERENCE TO RELATED APPLICATIONS

The application is a continuation of International Application No. PCT/CN2020/093447, filed on May 29, 2020, which claims priority to Chinese patent application No. 201911205289.X, filed on Nov. 29, 2019. The disclosures of International Application No. PCT/CN2020/093447 and Chinese Patent Application No. 201911205289.X are hereby incorporated by reference in their entireties.

### TECHNICAL FIELD

The disclosure relates to the technical field of image processing, and more particularly, to a method and apparatus for image processing, a device for image processing, and a storage medium.

### BACKGROUND

In the technical field of image processing, after a picture of a user is taken, an image transformation operation may need to be performed on a paster for a part of the picture. However, according to the solution of image deformation of a paster, a new image generated by performing image deformation on the paster has a poor deformation effect sometimes.

### SUMMARY

The embodiments of the disclosure are intended to provide a method and apparatus for image processing, a device for image processing, and a storage medium.

The technical solution of the embodiments of the disclosure is implemented as follows.

In a first aspect of embodiments of the disclosure, provided is a method for image processing, including: acquiring a first replacement image of a target part at a first posture; determining a posture parameter of the target part at a second posture in a first image; transforming the first replacement image into a second replacement image corresponding to the second posture according to the posture parameter; and fusing the second replacement image to the target part in the first image to obtain a second image.

In a second aspect of embodiments of the disclosure, provided is an apparatus for image processing, including: an acquisition module, configured to acquire a first replacement image of a target part at a first posture; a first determination module, configured to determine a posture parameter of the target part at a second posture in a first image; a transformation module, configured to transform the first replacement image into a second replacement image corresponding to the second posture according to the posture parameter; and a generation module, configured to fuse the second replacement image to the target part in the first image to obtain a second image.

In a third aspect of embodiments of the disclosure, provided is a device for image processing, including: a memory; and a processor, connected to the memory, and configured to execute computer-executable instructions stored in the memory to: acquire a first replacement image of a target part at a first posture; determine a posture parameter of the target part at a second posture in a first image; transform the first replacement image into a second replacement image corresponding to the second posture according to the posture parameter; and fuse the second replacement image to the target part in the first image to obtain a second image.

In a fourth aspect of embodiments of the disclosure, provided is a non-transitory computer storage medium having computer-executable instructions stored thereon, wherein the computer-executable instructions, when executed by a processor, implement a method for image processing, the method including: acquiring a first replacement image of a target part at a first posture; determining a posture parameter of the target part at a second posture in a first image; transforming the first replacement image into a second replacement image corresponding to the second posture according to the posture parameter; and fusing the second replacement image to the target part in the first image to obtain a second image.

### BRIEF DESCRIPTION OF THE DRAWINGS

FIG. 1 illustrates a schematic flowchart of a method for image processing according to embodiments of the disclosure.

FIG. 2 illustrates a schematic diagram of key points on a body contour according to embodiments of the disclosure.

FIG. 3 illustrates a schematic flowchart of generating a second replacement image according to embodiments of the disclosure.

FIG. 4 illustrates a schematic diagram of transforming an original triangular area into a target triangular area according to embodiments of the disclosure.

FIG. 5 illustrates a schematic comparison diagram of deformation with an abdomen as a target part according to embodiments of the disclosure.

FIG. 6 illustrates a schematic structural diagram of an apparatus for image processing according to embodiments of the disclosure.

FIG. 7 illustrates a schematic structural diagram of a device for image processing according to embodiments of the disclosure.

### DETAILED DESCRIPTION

The technical solutions of the embodiments of the disclosure are further described below in detail in combination with the accompanying drawings and specific embodiments of the specification.

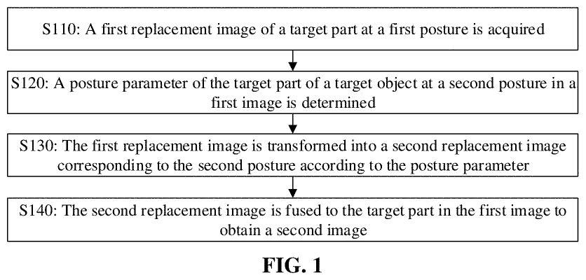

As illustrated in FIG. 1, a method for image processing is provided in the embodiment. The method includes the following actions.

In S110, a first replacement image of a target part at a first posture is acquired.

In S120, a posture parameter of the target part at a second posture in a first image is determined.

In S130, the first replacement image is transformed into a second replacement image corresponding to the second posture according to the posture parameter.

In S140, the second replacement image is fused to the target part in the first image to obtain a second image.

The method for image processing provided in the embodiment may be applied to electronic devices with an image processing function. Exemplarily, the electronic device may include various terminal devices, and the terminal devices include mobile phones or wearable devices. The terminal devices may also include: vehicle-mounted terminal device, or fixed terminal devices dedicated to image acquisition and fixed at a certain place. In some other embodiments, the electronic device may further include a server, for example, a local server or a cloud server that is located in a cloud platform and provides an image processing service.

In some embodiments, the target part is, for example, some part of a human body, or some part of an animal or other objects, and the embodiments of the disclosure do not set limitations herein.

In some embodiments, the first replacement image is, for example, a deformation effect image of the target part having been deformed. Exemplarily, in the case where the target part is the abdomen of a human body, the first replacement image may be, for example, an abdominal image having an abdominal muscle effect.

In some embodiments, the first posture and the second posture are used to describe a current pose state of the target part. Description is made with the abdomen of a human body as an example. When the human body stands, the abdomen is in an upright posture. When the human body bends the waist forwards, the abdomen is in a backward-bending posture, and when the human body bends the abdomen forwards, the abdomen is in a forward-bending posture. If the human body bends the waist to his/her right, the abdomen is in a right-side squeezed and left-side stretching posture; and if the human body bends the waist to his/her left, the abdomen is in a left-side squeezed and right-side stretching posture. As the waist of the human body is bent by a different amplitude in a motion, the posture may also be considered to be different. For example, the first posture may be an upright posture of the abdomen, and the second posture may be a bending posture of the abdomen bending in any of the afore-mentioned waist bending situations.

Before deforming the target part, the electronic device may have not stored first replacement images in various postures. At this time, a second replacement image corresponding to the second posture may be generated. The second replacement image may also be a deformation effect image of the target part having been deformed, and the second replacement image is a deformation effect image of the target part at the second posture.

In S140, the second replacement image may be fused into the first image in various ways to obtain the second image. In some embodiments, the second replacement image may be attached to the area where the target part is located in the first image, to obtain a second image, i.e. the second image is generated by means of layer attachment. For example, the first image is provided as a first layer; the second replacement image is added to a second layer, and the area in the second layer beyond the second replacement image is transparent; and layer fusion is performed by aligning the second replacement image with the target part in the first image, to obtain the second image.

In some other implementations, pixel values in the target area where the target part is located in the first image may be removed, and new pixel values are refilled, according to the second replacement image, into the target area where the pixel values have been removed. Removing a pixel value from the target area may include for example: setting the pixel value in the target area to a certain default value, or setting the transparency of the pixel area, where the target area is located, to a certain default value. The above-described refilling new pixel values into the target area from which the pixel values have been removed may include, for example: reassigning pixel values for the target area, and replacing, with a pixel value at any position in the second replacement image, the default value of a pixel at a corresponding position in the target area. The above is merely an example of generating a second image, and there may be many specific implementations, which will not be enumerated in the disclosure.

In the embodiment, instead of directly attaching the first replacement image of the target part at the first posture to the target part in the first image, the first replacement image is adjusted according to the posture parameter of the target part presented in the first image, to obtain a second replacement image consistent with the current posture (i.e., the second posture) of the target part; and the obtained second replacement image is then attached to the position where the target part is located in the first image, so as to generate a second image. Therefore, compared with the scheme that the first replacement image in the first posture is directly attached to the target part at the second posture in the first image, the deformation effect of the target part in the first image can be better.

In some optional embodiments, S130 may include: coordinates of each of a plurality of first key points of the target part in the first replacement image are acquired; at least one original polygonal area enclosed by a group of first key points among the plurality of first key points is determined from the first replacement image based on coordinates of the plurality of first key points; and the at least one original polygonal area is deformed based on the posture parameter to obtain the second replacement image.

According to the embodiment, by transforming the first replacement image into the second replacement image, the second replacement image can better conform to the actual posture of the target part.

In the embodiment, the original polygonal area may be an area enclosed by any polygon. The polygon may be a triangle, a quadrangle, a pentagon, etc., and the embodiment do not set limitations here.

In the embodiment, instead of performing a simple matrix transformation, the original polygonal area may be transformed through such as polygon affine transformation to obtain the target polygonal area. With the original polygonal area being an original triangular area as an example, the original triangular area may be transformed by triangle affine transformation to obtain the transformed target triangular area.

The detection of key points in the first replacement image in the embodiment may be realized by any existing key point detection method. For example, the first replacement image is input into a human body detection model to obtain coordinates of the key points (i.e., coordinates of the first key points) in the first replacement image.

In some optional embodiments, the method further includes: the position of the target part in the first image is determined according to the posture parameter. Correspondingly, S140 may include: the second replacement image is fused to the target area in the first image to obtain a second image. In the embodiment, the posture parameter may be indicated by coordinates of the key points of the target part in the first image, so that the coordinates of the key points may also be used for positioning the target part in the first image. The determined position of the target part in the first image facilitates fusing the second replacement image into the first image in S140 to generate a second image with a desired deformation effect.

In some embodiments, S120 may include: key point detection is performed for the target part in the first image to obtain coordinates of each of a plurality of key points of the target part in the first image; and the posture parameter of the target part is determined according to coordinates of the plurality of key points of the target part in the first image.

Exemplarily, a key point detection model may be utilized to perform key point detection for the target part in the first image. The key point detection model may be a deep learning model, e.g., various neural networks. In the embodiment, the key point detection model may be an open pose model.

According to the technical solution provided in the embodiments of the disclosure, in image deformation, instead of directly attaching a replacement image to a target part to be deformed in a first image, a posture parameter is obtained according to a current second posture of the target part to be deformed in the first image; according to the posture parameter, the first replacement image of the target part at the first posture is transformed into the second replacement image of the target part at the second posture, and then the second replacement image is fused into the first image to obtain a second image. Thus, due to the second image obtained by transformation, the phenomenon of poor deformation effect caused by a large difference of posture between the first replacement image and the target part in the first image is reduced, and the deformation effect of the target part in the first image can be effectively improved.

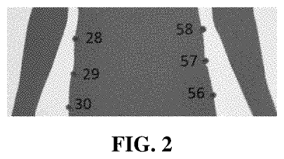

FIG. 2 illustrates a schematic diagram of key points on a body contour. In the embodiment, the target part is the abdomen as an example, and the key points of the target part for determining the posture parameter may be key points on the contour of the abdomen. The key points on the contour of the abdomen may refer to key points 28, 29 and 30, and key points 57, 58 and 56 in FIG. 2.

In some optional embodiments, S130 may include: affine transformation is performed, according to the posture parameter, on the first replacement image to obtain a second replacement image corresponding to the second posture. For example, the deformation of the original polygonal area or the deformation of the original triangular area in the above-described embodiment may both be realized by the affine transformation in the embodiment.

The above second replacement image corresponding to the second posture may include: a second replacement image in which the contained target part is at a second posture, or a second replacement image in which the contained target part is at a posture differing from the second posture by less than a preset value. Through a linear transformation operation and/or a translation operation in the affine transformation, the first replacement image is transformed into a second replacement image adapted with the second posture.

Exemplarily, a posture parameter of the first posture and the posture parameter of the second posture are taken as known quantities to perform fitting to obtain a transformation matrix for affine transformation. After the transformation matrix is obtained through the fitting, the position of each pixel in the first replacement image is transformed by using the transformation matrix, to obtain a second replacement image adapted with the second posture. Of course, this is merely an example of affine transformation and the specific implementation is not limited to this. Here, as in the foregoing embodiment, the posture parameter of the first posture and the posture parameter of the second posture may be indicated by coordinates of key points of the target part.

In some optional embodiments of the disclosure, the target part includes an abdomen, but the embodiments of the disclosure are not limited to the abdomen.

In some optional embodiments of the disclosure, the operation that the posture parameter of the target part at the second posture in the first image is determined includes: at least three types of key points of the abdomen are acquired. Herein, the at least three types of key points include: at least two first edge key points, at least two second edge key points and at least two central-axis key points. The at least two first edge key points are distributed at a different side of one of the at least two central-axis key points compared with the at least two second edge key points, and the positions of the at least three types of key points are configured to represent the posture parameter of the target part. Exemplarily, there may be two first edge key points and two second edge key points; and there may be three or four central-axis key points. Of course, the number of the first edge key points, the number of the second edge key points, and the number of the central-axis key points in the embodiment are not limited to the above examples.

In some optional embodiments, the central-axis key points may be determined according to the first edge key points and the second edge key points. In some other embodiments, the central-axis key points may be key points on the central axis of the skeleton of a target part, the skeleton of the target part being obtained using a model with a skeleton key point detection capability. For example, with the target part being the abdomen as an example, the central-axis key points of the abdomen may be obtained by detecting a key point at the center of the pelvic bone. In the embodiments of the disclosure, both the first edge key points and the second edge key points may be referred to as edge key points for brevity.

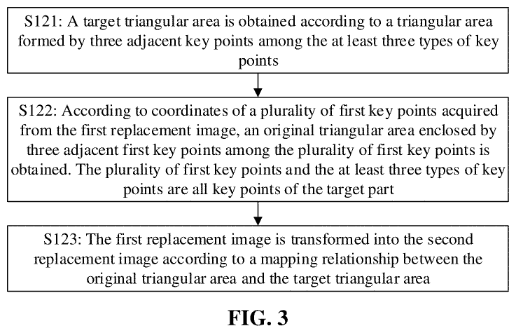

In some optional embodiments of the disclosure, in S130, the manner of transforming the first replacement image into the second replacement image corresponding to the second posture according to the posture parameter may be as illustrated in FIG. 3. S130 may include the following actions.

In S121, a target triangular area is obtained according to a triangular area formed by three adjacent key points among the at least three types of key points.

In S122, according to coordinates of a plurality of first key points acquired from the first replacement image, an original triangular area enclosed by three adjacent first key points among the plurality of first key points is obtained. The plurality of first key points and the at least three types of key points are all key points of the target part.

In S123, the first replacement image is transformed into the second replacement image according to a mapping relationship between the original triangular area and the target triangular area.

In the embodiment, by determining the mapping relationship between the original triangular area and the target triangular area and then according to an association relationship of changes of pixels in the image with changes of the triangular area, the first replacement image may be transformed into the second replacement image, so that the second replacement image corresponding to the second posture is obtained.

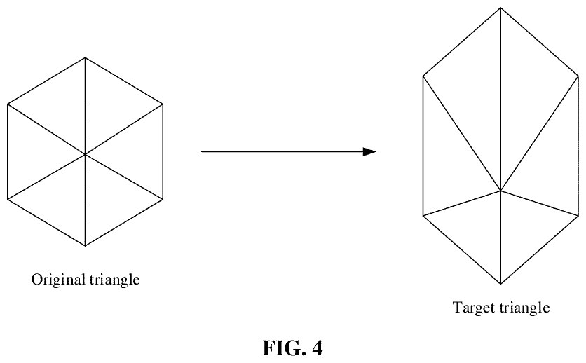

As illustrated in FIG. 4, in an original triangular area enclosed by any adjacent three first key points, the vertexes of the original triangular area at least include a central-axis key point and at least one edge key point. In some examples, an original triangular area may be obtained by arbitrarily connecting any three key points distributed adjacently among the aforementioned three types of key points. In some other examples, three key points among at least two types of key points are connected to obtain an original triangular area; at this time, the key points corresponding to the three vertices of the original triangular area belong to at least two types of the aforementioned three types of key points. For example, the edge key points on the left side in the original triangular area of FIG. 4 are first edge key points, and the edge key points on the right side are second edge key points. The key points at the center are central-axis key points.

By affine transformation of the original triangular area, the side length and shape of the original triangular area may be changed to obtain the target triangular area illustrated in FIG. 4.

Through affine transformation of the original triangular area, the deformation amount of an edge portion and a middle portion of the target part cannot be greatly different. Thus, the deformation of the edge portion and the middle portion are continuous, and the deformation effect is improved.

One specific example is provided below in connection with any of the above embodiments.

The present example may be applied in a scenario where the abdomen in a human body image is deformed. A user may upload, in a terminal device, a human body image to be processed, to serve as a first image, and the user selects the abdomen in the human body image as a target part. Further, multiple paster images with abdominal deformation effects such as a paster image with an effect of eight abdominal muscles and a paster image with an effect of four abdominal muscles may be provided in the terminal device.

The user may select a target paster image, such as the paster image with the effect of eight abdominal muscles, from the multiple paster images as the first replacement image.

In the process of deforming the abdomen in the human body image according to the target paster image, considering that the posture in the target paster image may be a first posture, and the abdomen in the human body image is actually at a second posture, if the target paster image is directly attached, the final abdomen deformation effect may not match with the actual second posture, and the deformation effect is poor.

Based on this, in the embodiments of the disclosure, key points of the abdomen in the human body image may be recognized firstly, to obtain coordinates of the key points of the abdomen, in particular coordinates of key points on the contour of the abdomen. Thus, the posture parameter of the abdomen in the human body image can be determined based on the coordinates of the key points of the abdomen.

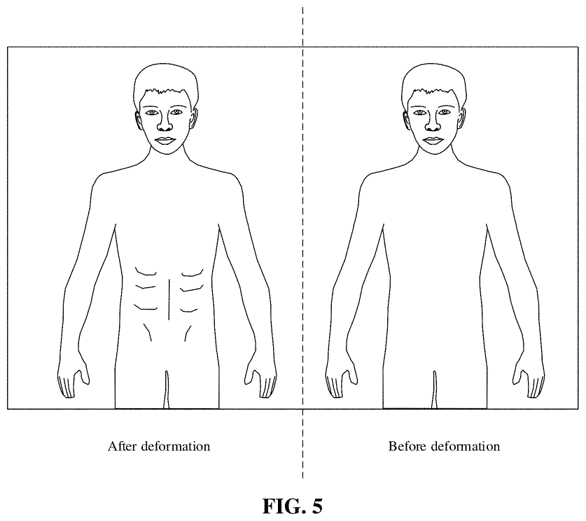

Further, the target paster image may be transformed into a paster image (i.e., the second replacement image) corresponding to the second posture according to the posture parameter of the abdomen. The transformation process may be implemented by means of polygon affine transformation. A particular affine transformation process may refer to the embodiments described above. As illustrated in FIG. 5, a human body image with the abdomen at a second posture is illustrated on the right side of FIG. 5, and the human body image fused with a paster image corresponding to the second posture is illustrated on the left side of FIG. 5.

Finally, the paster image corresponding to the second posture may be fused to the area where the target part is located in the first image, to obtain the human body image with the desired deformation effect, namely the second image.

Therefore, the second image obtained through fusion reduces the phenomenon of poor deformation effect caused by large difference of postures between the first replacement image and the target part in the first image, and improves the deformation effect of the target part in the first image.

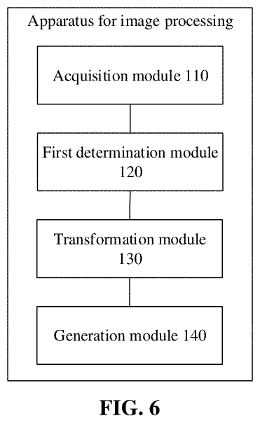

As illustrated in FIG. 6, an apparatus for image processing is also provided in embodiments of the disclosure. The apparatus includes: an acquisition module 110, a first determination module 120, a transformation module 130, and a generation module 140.

The acquisition module 110 is configured to acquire a first replacement image of a target part at a first posture.

The first determination module 120 is configured to determine a posture parameter of the target part at a second posture in a first image.

The transformation module 130 is configured to transform the first replacement image into a second replacement image corresponding to the second posture according to the posture parameter.

The generation module 140 is configured to fuse the second replacement image to the target part in the first image to obtain a second image.

In some embodiments, the acquisition module 110, the first determination module 120, the transformation module 130, and the generation module 140 are all program modules which, when executed by a processor, can realize the function of any of the modules described above.

In some other embodiments, the acquisition module 110, the first determination module 120, the transformation module 130, and the generation module 140 are software and hardware combined modules. The software and hardware combined modules include, but are not limited to, programmable arrays. The programmable arrays include, but are not limited to, field programmable arrays and complex programmable arrays.

In yet some embodiments, the acquisition module 110, the first determination module 120, the transformation module 130, and the generation module 140 are pure hardware modules. The pure hardware modules include, but are not limited to, application-specific integrated circuits.

In some embodiments, the transformation module 130 is configured to: acquire coordinates of each of a plurality of first key points of the target part in the first replacement image; determine, from the first replacement image based on coordinates of the plurality of first key points, at least one original polygonal area enclosed by a group of first key points among the plurality of first key points; and deform the at least one original polygonal area based on the posture parameter to obtain the second replacement image.

In some embodiments, the first determination module 120 is configured to: perform key point detection for the target part in the first image to obtain coordinates of each of a plurality of key points of the target part in the first image; determine the posture parameter of the target part according to coordinates of the plurality of key points of the target part in the first image.

In some embodiments, the target part includes an abdomen. The first determination module 120 is configured to acquire coordinates of each of at least three types of key points of the abdomen in the first image. The at least three types of key points include: at least two first edge key points, at least two second edge key points and at least two central-axis key points. The at least two first edge key points are distributed at a different side of one of the at least two central-axis key points compared with the at least two second edge key points. Positions of the at least three types of key points are configured to represent the posture parameter of the target part.

In some embodiments, the transformation module 130 is configured to obtain a target triangular area according to a triangular area formed by three adjacent key points among the at least three types of key points. The transformation module 130 is configured to obtain, according to coordinates of a plurality of first key points acquired from the first replacement image, an original triangular area enclosed by three adjacent first key points among the plurality of first key points. The plurality of first key points and the at least three types of key points are all key points of the target part. The transformation module 130 is configured to transform the first replacement image into the second replacement image according to a mapping relationship between the original triangular area and the target triangular area.

In some embodiments, the apparatus further includes: a second determination module, configured to determine, according to the posture parameter, a target area where the target part is located in the first image.

The generation module 140 is configured to fuse the second replacement image to the target area in the first image to obtain a second image.

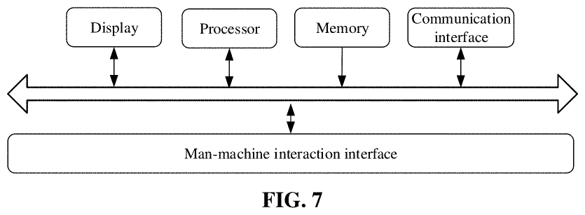

As illustrated in FIG. 7, in embodiments of the disclosure, further provided is a device for image processing, which includes a memory and a processor.

The memory is configured to store computer-executable instructions.

The processor is connected to a display and the memory respectively, and configured to implement, by executing the computer-executable instructions stored in the memory, the method for image processing provided in one or more of the foregoing technical solutions, for example, the method for image processing illustrated in FIG. 1 and/or FIG. 4.

The memory may be various types of memories, and may be a Random Access Memory (RAM), a Read-Only Memory (ROM), a flash memory, etc. The memory may be configured to store information, for example, store the computer-executable instructions. The computer-executable instructions may be various program instructions, such as target program instructions and/or source program instructions.

The processor may be various types of processors, such as a central processor, a microprocessor, a digital signal processor, a programmable array, a digital signal processor, an application-specific integrated circuit, or an image processor.

The processor may be connected to the memory through a bus. The bus may be an integrated circuit bus, etc.

In some embodiments, the terminal device may further include: a communication interface. The communication interface may include a network interface. The network interface may include, for example, a local area network interface, a transceiver antenna, etc. The communication interface is also connected to the processor, and can be used for information transceiving.

In some embodiments, the terminal device further includes a man-machine interaction interface. For example, the man-machine interaction interface may include various input/output devices, such as a keyboard and a touch screen.

In some embodiments, the device for image processing further includes: a display, which may display various prompt information, various acquired face images, various interfaces, etc.

The embodiments of the disclosure also provide a computer storage medium having computer-executable code stored thereon. The computer-executable code is executed to implement the method for image processing provided in one or more of the foregoing technical solutions, for example, the method for image processing illustrated in FIG. 1 and/or FIG. 4.

In the several embodiments provided in the disclosure, it should be understood that the disclosed device and method may be implemented in other manners. The device embodiment described above is only schematic, and for example, division of the units is only division in logic functions, and other division manners may be used during practical implementation. For example, multiple units or components may be combined or integrated into another system, or some characteristics may be neglected or not executed. In addition, coupling or direct coupling or communication connection between displayed or discussed components may be indirect coupling or communication connection implemented through some interfaces, devices or units, and may be electrical and mechanical or in other forms.

The units described as separate parts may or may not be physically separated, and parts displayed as units may or may not be physical units, and namely may be located in the same place, or may also be distributed to multiple network units. Part or all of the units may be selected according to a practical requirement to achieve the purpose of the solutions of the embodiment.

In addition, various function units in the embodiments of the disclosure may be integrated into a processing module, each unit may also exist independently, and two or more units may also be integrated into one unit. The integrated unit may be implemented in a hardware form, or may be implemented in form of hardware plus software function unit.

The technical features disclosed in any embodiment of the disclosure may be arbitrarily combined to form a new method embodiment or a device embodiment without conflict.

The method embodiments disclosed in any embodiment of the disclosure may be arbitrarily combined to form a new method embodiment without conflict.

The device embodiments disclosed in any embodiment of the disclosure may be arbitrarily combined to form a new device embodiment without conflict.

Those of ordinary skill in the art should know that: all or part of the steps of the above method embodiment may be implemented by instructing related hardware through a program, the above program may be stored in a computer-readable storage medium, and the program, when executed, performs the steps of the above method embodiment. The storage medium includes: various media capable of storing program codes such as a mobile storage device, a ROM, a RAM, a magnetic disk or an optical disc.

The above is only detailed description of the disclosure and is not intended to limit the scope of protection of the disclosure. Any variations or replacements apparent to those skilled in the art within the technical scope disclosed by the disclosure shall fall within the scope of protection of the disclosure. Therefore, the scope of protection of the disclosure shall be subjected to the scope of protection of the claims.

1. A method for image processing, comprising:
acquiring a first replacement image of a target part at a first posture;
determining a posture parameter of the target part at a second posture in a first image;
transforming the first replacement image into a second replacement image corresponding to the second posture according to the posture parameter; and
fusing the second replacement image to the target part in the first image to obtain a second image.

2. The method according to claim 1, wherein transforming the first replacement image into the second replacement image corresponding to the second posture according to the posture parameter comprises:
acquiring coordinates of each of a plurality of first key points of the target part in the first replacement image;
determining, from the first replacement image based on coordinates of the plurality of first key points, at least one original polygonal area enclosed by a group of first key points among the plurality of first key points; and
deforming the at least one original polygonal area based on the posture parameter to obtain the second replacement image.

3. The method according to claim 1, wherein determining the posture parameter of the target part at the second posture in the first image comprises:
performing key point detection for the target part in the first image to obtain coordinates of each of a plurality of key points of the target part in the first image; and
determining the posture parameter of the target part according to coordinates of the plurality of key points of the target part in the first image.

4. The method according to claim 1, wherein the target part comprises an abdomen; and
determining the posture parameter of the target part at the second posture in the first image comprises:
acquiring coordinates of each of at least three types of key points of the abdomen in the first image, wherein the at least three types of key points comprise: at least two first edge key points, at least two second edge key points and at least two central-axis key points, the at least two first edge key points are distributed at a different side of one of the at least two central-axis key points compared with the at least two second edge key points, and positions of the at least three types of key points are configured to represent the posture parameter of the target part.

5. The method according to claim 4, wherein transforming the first replacement image into the second replacement image corresponding to the second posture according to the posture parameter comprises:
obtaining a target triangular area according to a triangular area formed by three adjacent key points among the at least three types of key points;
obtaining, according to coordinates of a plurality of first key points acquired from the first replacement image, an original triangular area enclosed by three adjacent first key points among the plurality of first key points, wherein the plurality of first key points and the at least three types of key points are all key points of the target part; and
transforming the first replacement image into the second replacement image according to a mapping relationship between the original triangular area and the target triangular area.

6. The method according to claim 1, further comprising:
determining, according to the posture parameter, a target area where the target part is located in the first image,
wherein fusing the second replacement image to the target part in the first image to obtain the second image comprises:
fusing the second replacement image to the target area in the first image to obtain the second image.

7. The method according to claim 6, wherein fusing the second replacement image to the target area in the first image to obtain the second image comprises:
setting all pixel values in the target area in the first image to be a default pixel value; and replacing the default pixel value at each position in the target area in the first image with a respective pixel value at a same position in the second replacement image; or
setting transparency in the target area in the first image to be a default transparency;
and replacing each of the pixel values in the target area in the first image with a respective pixel value at a same position in the second replacement image.

8. An apparatus for image processing, comprising:
a memory; and
a processor, connected to the memory, and configured to execute computer-executable instructions stored in the memory to:
acquire a first replacement image of a target part at a first posture;
determine a posture parameter of the target part at a second posture in a first image;
transform the first replacement image into a second replacement image corresponding to the second posture according to the posture parameter; and
fuse the second replacement image to the target part in the first image to obtain a second image.

9. The apparatus according to claim 8, wherein in transforming the first replacement image into the second replacement image corresponding to the second posture according to the posture parameter, the processor is configured to execute the computer-executable instructions stored in the memory to:
acquire coordinates of each of a plurality of first key points of the target part in the first replacement image;
determine, from the first replacement image based on coordinates of the plurality of first key points, at least one original polygonal area enclosed by a group of first key points among the plurality of first key points; and
deform the at least one original polygonal area based on the posture parameter to obtain the second replacement image.

10. The apparatus according to claim 8, wherein in determining the posture parameter of the target part at the second posture in the first image, the processor is configured to execute the computer-executable instructions stored in the memory to:
perform key point detection for the target part in the first image to obtain coordinates of each of a plurality of key points of the target part in the first image; and
determine the posture parameter of the target part according to coordinates of the plurality of key points of the target part in the first image.

11. The apparatus according to claim 8, wherein the target part comprises an abdomen; and the processor is configured to execute the computer-executable instructions stored in the memory to:
acquire coordinates of each of at least three types of key points of the abdomen in the first image, wherein the at least three types of key points comprise: at least two first edge key points, at least two second edge key points and at least two central-axis key points, the at least two first edge key points are distributed at a different side of one of the at least two central-axis key points compared with the at least two second edge key points, and positions of the at least three types of key points are configured to represent the posture parameter of the target part.

12. The apparatus according to claim 11, wherein in transforming the first replacement image into the second replacement image corresponding to the second posture according to the posture parameter, the processor is configured to execute the computer-executable instructions stored in the memory to:
obtain a target triangular area according to a triangular area formed by three adjacent key points among the at least three types of key points;
obtain, according to coordinates of a plurality of first key points acquired from the first replacement image, an original triangular area enclosed by three adjacent first key points among the plurality of first key points, wherein the plurality of first key points and the at least three types of key points are all key points of the target part; and
transform the first replacement image into the second replacement image according to a mapping relationship between the original triangular area and the target triangular area.

13. The apparatus according to claim 8, wherein the processor is configured to execute the computer-executable instructions stored in the memory to:
determine, according to the posture parameter, a target area where the target part is located in the first image, and
fuse the second replacement image to the target area in the first image to obtain the second image.

14. The apparatus according to claim 13, wherein in fusing the second replacement image to the target area in the first image to obtain the second image, the processor is configured to execute computer-executable instructions stored in the memory to:
set all pixel values in the target area in the first image to be a default pixel value; and replace the default pixel value at each position in the target area in the first image with a respective pixel value at a same position in the second replacement image; or
set transparency in the target area in the first image to be a default transparency; and replace each of the pixel values in the target area in the first image with a respective pixel value at a same position in the second replacement image.

15. A non-transitory computer storage medium having computer-executable instructions stored thereon, wherein the computer-executable instructions, when executed by a processor, implement a method for image processing, the method comprising:
acquiring a first replacement image of a target part at a first posture;
determining a posture parameter of the target part at a second posture in a first image;
transforming the first replacement image into a second replacement image corresponding to the second posture according to the posture parameter; and
fusing the second replacement image to the target part in the first image to obtain a second image.

16. The non-transitory computer storage medium according to claim 15, wherein transforming the first replacement image into the second replacement image corresponding to the second posture according to the posture parameter comprises:
acquiring coordinates of each of a plurality of first key points of the target part in the first replacement image;
determining, from the first replacement image based on coordinates of the plurality of first key points, at least one original polygonal area enclosed by a group of first key points among the plurality of first key points; and
deforming the at least one original polygonal area based on the posture parameter to obtain the second replacement image.

17. The non-transitory computer storage medium according to claim 15, wherein determining the posture parameter of the target part at the second posture in the first image comprises:
performing key point detection for the target part in the first image to obtain coordinates of each of a plurality of key points of the target part in the first image; and
determining the posture parameter of the target part according to coordinates of the plurality of key points of the target part in the first image.

18. The non-transitory computer storage medium according to claim 15, wherein the target part comprises an abdomen; and
determining the posture parameter of the target part at the second posture in the first image comprises:
acquiring coordinates of each of at least three types of key points of the abdomen in the first image, wherein the at least three types of key points comprise: at least two first edge key points, at least two second edge key points and at least two central-axis key points, the at least two first edge key points are distributed at a different side of one of the at least two central-axis key points compared with the at least two second edge key points, and positions of the at least three types of key points are configured to represent the posture parameter of the target part.

19. The non-transitory computer storage medium according to claim 18, wherein transforming the first replacement image into the second replacement image corresponding to the second posture according to the posture parameter comprises:
obtaining a target triangular area according to a triangular area formed by three adjacent key points among the at least three types of key points;
obtaining, according to coordinates of a plurality of first key points acquired from the first replacement image, an original triangular area enclosed by three adjacent first key points among the plurality of first key points, wherein the plurality of first key points and the at least three types of key points are all key points of the target part; and
transforming the first replacement image into the second replacement image according to a mapping relationship between the original triangular area and the target triangular area.

20. The non-transitory computer storage medium according to claim 15, wherein the method further comprises:
determining, according to the posture parameter, a target area where the target part is located in the first image,
wherein fusing the second replacement image to the target part in the first image to obtain the second image comprises:
fusing the second replacement image to the target area in the first image to obtain the second image.
